(19) United States
(12) Patent Application Publication
(10) Pub. No.: US 2018/0150861 A1
(43) Pub. Date: May 31, 2018

(54) Prepaid Bonus System

(71) Applicant: Mathew MEGENS, Woking (GB)

(72) Inventor: Mathew MEGENS, Woking (GB)

(21) Appl. No.: 15/501,147

(22) PCT Filed: Aug. 17, 2016
(86) PCT No.: PCT/US2016/047433

§ 371 Date: Feb. 1, 2017

Related U.S. Application Data
(60) Provisional application No. 62/206,167, filed on Aug. 17, 2015.

(51) Int. Cl. G06Q 30/02; G06Q 20/38; G06Q 20/28; G06Q 20/32; G06Q 20/36

(52) U.S. Cl. CPC G06Q 30/0215; G06Q 20/387; G06Q 20/36; G06Q 20/3274; G06Q 20/28

(57) ABSTRACT

A prepaid bonus system comprising the steps of determining a discount rate, depositing money into a mobile secure wallet, the system transferring money into a retailer account, the retailer receiving funds from the user, the prepaid account growing by the amount of the discount rate, the prepaid account balance showing on an account odometer and the consumer spending the prepaid balance on purchasing from the retailer. The prepaid bonus system wherein the prepaid balance is provided to the consumer as a QR code for the retailer to scan at purchase. The prepaid bonus system wherein the consumer may transfer the prepaid balance to another user. The prepaid bonus system further comprising the step of the consumer communicating with a financial tutor.

### BACKGROUND OF THE INVENTION

### 1. Field of Invention

This invention relates to an electronic system for receiving funds and dispensing the funds electronically, and accruing purchasing power to stored funds. The system uses financial incentives to encourage saving behavior versus borrowing behavior and provides an interface that makes this process fun and educational.

### 2. Description of Related Art

In the prior art, bank accounts exist for depositing money and a small amount of interest is typically earned on the deposit. Deposit certificates hold the money for a longer, set period and then return the amount with interest. The sums on deposit are leant by banks to borrowers, who repay the amounts with interest. Lending and receiving interest does not benefit a store that a depositer frequents, and due to the small amount of interest does not really provide a significant benefit to the depositer. In fact, the main beneficiary is the bank. Lending in return for the capital plus interest is forbidden in Muslim societies, due to Sharia law which states that money has no intrinsic value and thus one cannot profit from exchanging money. However, there are Sharia-compliant banking products that typically work on the basis that capital is used to purchase some good for a profit and the profit figure should be associated with a form of investment or trade. The structure of the prepaid bonus system allows for a consumer to purchase goods in advance from a retailer and for the retailer to deliver the goods to the consumer at the consumer's discretion. When the retailer delivers the goods, they will provide an increased value of good in return for the consumer's business loyalty and enabling the business to more efficiently operate their business.

Additionally, retailers had to acquire customers via traditional marketing and advertising campaigns, paying fees to third parties in addition to fees paid for working capital to third parties in order to obtain a sale. It would be better for both the consumer and the retailer if this value (advertising fees and financing fees) could be transferred to their customer rather than a third party. The prepaid bonus system enables a value transfer not currently present in the market which benefits both parties in the core retail transaction.

Additionally, while retailers have reward programs and loyalty programs to retain customers, these programs have a static reward which rarely if ever changes. The prepaid bonus system acts as a form of reward however rather than a static reward, the prepaid bonus system allows the ability to dynamically change the reward rates and amounts. In doing so, the optimum reward which maximizes value to consumer and minimizes cost to the retailer can be attained. Besides the ability to set varying reward rates, the prepaid bonus system gathers data from existing programs and then analyses this data to determine a suitable program rate. The prepaid bonus system then constantly monitors feedback and suggests new rates to optimize consumer behavior according to the retailers' wishes (for example, minimizing cost, maximizing usage, encouraging redemption). The prepaid bonus system thus acts as series of algorithms, which allow the retailer to optimize consumer behavior via the use of rewards attained from value that would have otherwise gone to third parties.

Additionally, it is difficult to determine the real-time value of the savings deposit. An odometer to show the savings would be helpful for an up-to-the-minute update on the value of the savings and interest.

Therefore there is a need for a savings device that enables funds to be deposited and used by a store in exchange for store credit and a coupon value provided by the store, to increase the purchasing power of the store credit. In addition, there is a need for an easy device by which the store credit and coupon value may be monitored. Finally, there is a need for a device that allows users to ‘gift’ store credit to other users where the gift can increase in value and where this ‘gift’ can be gifted to a recipient with certain preconditions prior to having full access of the gift. All these transactions need to be monitored to ensure accuracy and since consumers are in effect providing capital to businesses, there needs to be legal documentation to support their prepayment in the case of any dispute and that the retailer owes the consumer a future ‘payment’ of goods. The system would need to monitor this documentation for each user.

### SUMMARY OF THE INVENTION

A prepaid bonus system comprising the steps of determining a discount rate, depositing money into a mobile secure wallet, the system transferring money into a retailer account, the retailer receiving funds from the user, the prepaid account growing by the amount of the discount rate, the prepaid account balance showing on an account odometer and the consumer spending the prepaid balance on purchasing from the retailer. The prepaid bonus system wherein the prepaid balance is provided to the consumer as a QR code for the retailer to scan at purchase. The prepaid bonus system wherein the consumer may transfer the prepaid balance to another user. The prepaid bonus system further comprising the step of the consumer communicating with a financial tutor.

The prepaid bonus system has an account odometer the odometer compresses zeros wherein the zeros will shrink when there are zeros between the decimal place and the incrementing numbers, wherein the digits become smaller and shrink in width, and wherein as a zero increments into a higher unit digit, it will expand back to normal font size.

In an embodiment, the prepaid balance is provided to the consumer as a QR code for the retailer to scan at purchase. The consumer may transfer the prepaid balance to another user, and may have the further step of the consumer communicating with a financial tutor.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIGS. 1a and 1b are a data diagram showing the data flow for the user interface, according to an embodiment of the present invention;

FIG. 2 shows the method steps from a retailer viewpoint, according to an embodiment of the present invention;

FIG. 3 shows the method steps from an application layer viewpoint, according to an embodiment of the present invention; and

FIG. 4 shows a functional diagram of the system, according to an embodiment of the present invention.

### DETAILED DESCRIPTION OF PREFERRED EMBODIMENTS

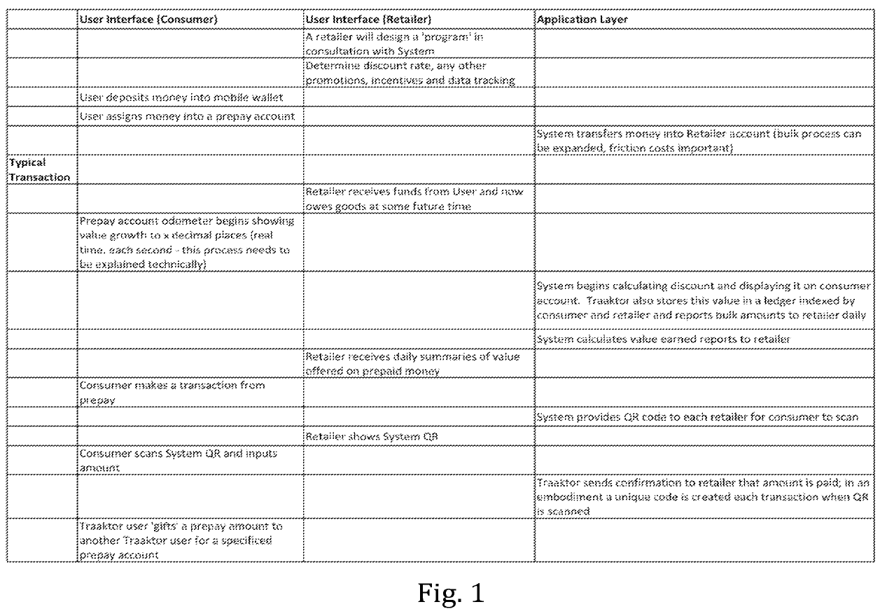

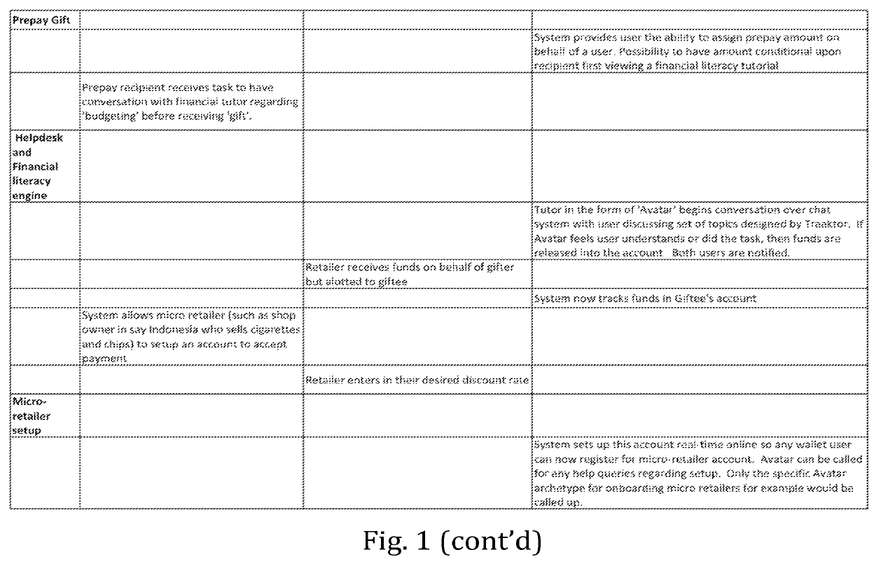

Preferred embodiments of the present invention and their advantages may be understood by referring to FIGS. 1-4 wherein like reference numerals refer to like elements.

The prepaid bonus system is a savings tool. It helps those in developing countries without ready access to banks to preserve capital and receive “interest” from merchants. It enforces discipline and budgeting in its users and encourages financial literacy. It also benefits merchants by engendering loyalty, and increases service quality by permitting tracking of purchases. The system also allows an alternative form of working capital finance for businesses where they are in effect funded by their customers rather than by banks. It allows retailers to transfer value otherwise paid to third parties such as advertising firms and banks directly to consumers to encourage sales. It also allows retailers to determine an optimum reward rate through algorithmic methods rather than guessing. This can be applied both to large multinational businesses with well-known reputations or with micro sole retailers who have a reputation within their community. Transactions for micro retailers will be recorded and will automatically create an eBay style ‘credit score’ that can than be used by traditional banking institutions to open up more financial tools to under banked communities.

In an embodiment of the invention, a user prepays a sum to a merchant account. The amount is held within the merchant account and may be used for purchases by the user from the merchant. Once deposited, the merchant may also provide a pre-agreed bonus or incentive to the user for the deposit (typically 5%-10% of the amount). The amount also accrues purchasing power based on an annual rate, such that the amount increases, moment by moment. These additional amounts may also be used by the user at the merchant to pay for goods. The total amount including the amount and the interest, is shown to the user as an “odometer” that is constantly increasing, to show the increasing interest value. The total amount is adjusted according to purchases or redemptions by the user.

This odometer would be set to a number of decimal places to show a continuously counting amount. In my most cases, 10 decimal places would be appropriate to show movement even on small accounts but this will vary depending on amount deposited and rate of bonus. In addition, the odometer will include ‘compressing zeros’. Compressing zeros are graphically enabled ‘zeros’ that will shrink when there are zeros between the decimal place and the incrementing numbers, wherein the digits become smaller and shrink in width. As a zero increments into a higher unit digit, it will expand back to normal font size. This visual effect will enable a more pleasant appearing odometer whilst still providing precise information to the user.

There may be a facility for auto-deposits to maintain a minimum balance of the account to promote saving. As the account is stored electronically, there is facility to pay the merchant or other merchants through the account. The bonus may be altered depending on the amount of time a user has been contributing to the amount.

The user can receive some or all of the amount (optionally with a redemption fee) as a withdrawal without the “interest”, however the merchants will receive the borrowed money without charge, as the interest or incentive is reduced according to the money removed.

In order to assist user with building credit, automated reports are sent on the payment history to various credit reporting agencies. Metadata of the transactions and flow to various merchants and geographic areas, which may be beneficial to the central planning of an economy. This is especially valid for micro-retailers who would typically deal with cash and are likely unbanked. By using a mobile wallet anyone with a mobile phone can both save electronically as well as borrow electronically, thus building a credit history in the process.

Data collected from offers will enable retailers to use an automated process to set their reward rates. In doing so, the prepaid bonus system can find a reward value to achieve a retailers optimum goals whether that be maximum number of users or a set amount of sales whilst minimizing the cost to do so. The retailer can choose to set rates manually or use the data learning by the system to automatically choose a rate within predefined constraints (e.g. budget, date deadlines).

A marketing portal for retail users of the system is another feature. Presently, there exist few natural Internet-based portals where consumers seek out retail marketing. Google Search is one of the few sites that achieve this. Other advertising portals such as Facebook are invaded by marketing rather than natural homes. The prepaid bonus system on the other hand becomes a portal where users are self-identifying as clearly wanting to make a future purchase and thus are planning to spend money for consumption in the future. Thus, the system becomes a natural place for retailers to advertise offers to compete for new users or encourage greater spend from existing customers.

Financial literacy is a core component of the system, wherein the user is induced to contribute to his or her account to view the increase in amount based on the interest. In developing economies, the merchants may be providers of essentials such as groceries for the survival of small households. Educational scripts can be provided and financial education may be provided through an avatar and using the system in tutorial mode. The avatar provides a character with which users interact and associate. The user and avatar work through the mathematics together, determining the discount rate or “interest” rate, and/or mathematical examples. Real-world examples remind of deadlines and items that the user is saving towards. Education can be delivered via cartoons or voice text for illiterate users to provide the greatest reach.

Incentives are also a core component of the system. The system will allow connected parties to transfer funds into a prepaid account conditionally. The condition could be the user requiring to first view an education tutorial on financial literacy or a public health good. Upon viewing the tutorial, the funds could then be released. This incentive could be used by governments providing social payments or by parents providing gifts to their children. The system will allow this conditional payment mechanism to be conducted in a highly scalable manner. The incentive system also becomes highly valuable for when a user ‘gifts’ prepay to another user a simple example could be a parent gifting prepay to a grocery store to a child in university. Firstly, the parent knows the funds will be used at a grocery store and reduces the risk of the money being wasted frivolously and secondly the system allows the gifter to tie conditions prior to the release of the prepaid funds (in this example it could be a requirement to first call home to mom, once the child calls mom the parents can ‘release’ the prepay gift).

In an embodiment, the system allows users to be interconnected to transfer amounts between users or with merchants that have accounts on the system.

With reference to FIGS. 1a and 1b, the user interactivity is shown. In step 7, the retailer designs a program in consultation with the system. In step 8, the discount rate is determined and promotions and incentives may be added. In step 10 the user deposits money into an e-commerce account or mobile wallet (e-wallet). In step 15 the user assigns the money to a merchant prepay account and the money enters the account. In step 17, the system transfers money in the retailer account, and in step 19 the retailer receives the funds from the user, and owes goods or services at a future time. In a typical transaction, in step 20 the prepay odometer shows value growth in real time by reviewing the account balance and adding “interest” added for the day so far. The odometer also compresses digits as described above, in an embodiment. As an example, assume $100 was deposited at a pre-agreed purchasing power ‘boost’ rate of 10% per annum. If no amounts were spent, after one year the account would be worth $110. However, the device will show growth in real time each second. For the above example, the ‘growth odometer’ would be built to 10 decimal places, so that second-to-second changes may be shown in the numbers. As each second passes, the account would grow by $0.0000003171, determined from calculating (100×0.1 interest)/365 days/24 hours/60 minutes/60 seconds. In step 21, the system calculates the discount and displays it on the consumer account. In step 22, the system calculates the value earned and reports the retailer. In step 23, the retailer receives a daily summary of the value offered on prepaid money. In step 25, the user makes a transaction, such as a payment to the merchant or associated retailer, from the prepay account. In step 27, the system provides a CR code to each retailer for the consumer to scan. In step 28 the retailer shows the system QR code. The transaction may be automated, from a smartphone through the use of a bar code or near-field network, alternatively. In step 30, users also send gift cards to other users who are registered on the system, transferring all or part of their balance to the other user to be used with the merchant. In step 32, the system sends confirmation to the retailer that the amount is paid.

In the Prepay Gift Card category, in step 33 the system provides a user the ability to assign a prepay amount on behalf of a user or to another user. In step 34, the system provides the user with the ability to assign prepay amounts on behalf of a user. In step 35, the recipient has a conversation with a financial tutor (avatar) before receiving the gift.

In the Helpdesk and Financial literacy engine category, in step 37 in the application layer a tutor in the form of an avatar begins a conversation with a user discussing a number of financial topics. In step 38, the retailer receives funds on behalf of the gifter. In step 40, the system tracks funds in the giftee's account. In step 45 the system allows the micro-retailer to set up an account to accept payment. In step 47 the retailer provides a discount rate for pre-acceptance of the funds, and in step 49, in the Micro-Retailer Setup category, in the application layer the system sets up an account so any wallet user may register for a micro-retailer account.

The system allows prepay growth to be ‘pushed’ or ‘pulled’. i.e. For ‘push’ which typically involves an undefined future redemption date—A user could either say deposit $100 and it grows over time to say $110 in one year at a 10% growth rate. For ‘pull’ which typically involves a defined future redemption date A user might know they want to spend $100 in the near future so wants to know what amount to deposit in advance so upon setting the target amount and date the system will inform in real time the amount to deposit to reach the goal (e.g. $100 one year in advance if they want $110). It's a subtle difference but important when applications such as dance classes are used where a customer knows they will be buying a dance class for say $100 at the beginning of term. They would have no use for reward beyond the $100 so thus would want to know the precise amount to deposit in advance to hit their target exactly as they know their precise redemption date.

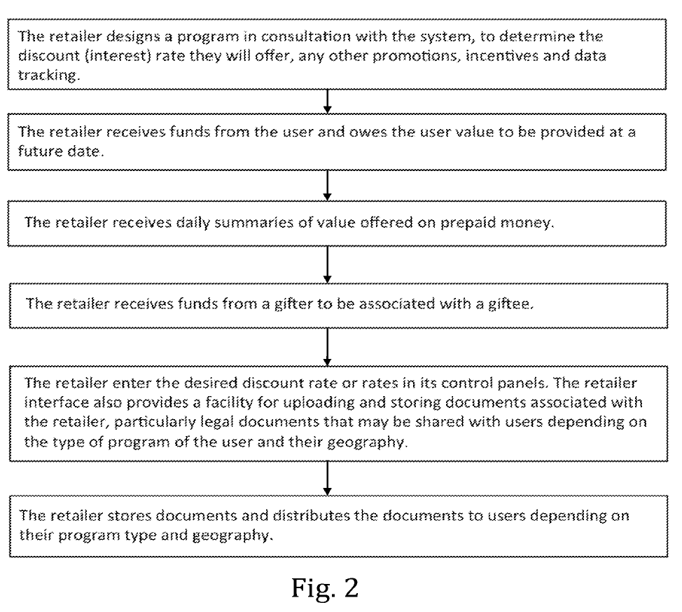

With reference to FIG. 2, the retailer interface is shown. In step 50, the retailer designs a program in consultation with the system, to determine the discount (interest) rate they will offer, any other promotions, incentives and data tracking. In step 55, the retailer receives funds from the user and owes the user value to be provided at a future date. In step 60 the retailer receives daily summaries of value offered on prepaid money. In step 65 the retailer receives funds from a gifter to be associated with a giftee. In step 70, the retailer enter the desired discount rate or rates in its control panels. The retailer interface also provides a facility for uploading and storing documents associated with the retailer, particularly legal documents that may be shared with users depending on the type of program of the user and their geography. In step 75, the retailer stores documents and distributes the documents to users depending on their program type and geography.

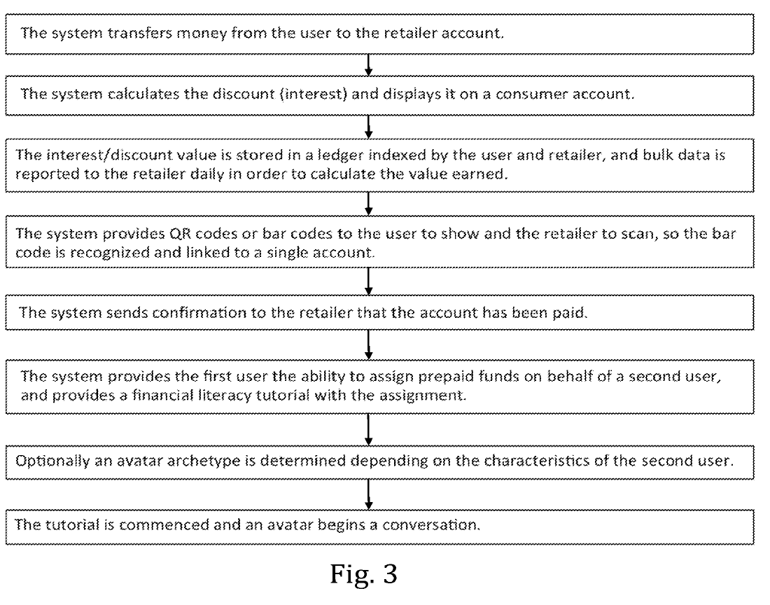

With reference to FIG. 3, the application layer is described, wherein in step 100 the system transfers money from the user to the retailer account. For these transactions, transaction costs are minimized by performing bulk processes and reducing frictions costs. In an embodiment transfers would be made once per day and purchasing power benefit would not accrue until amounts have cleared the destination account. Money will be transferred in bulk amounts aggregating individual accounts. The system would then send a separate file that reconciles the bulk amount with each individual depositor. In step 105 the system calculates the discount (interest) and displays it on a consumer account. In step 110 this value is stored in a ledger indexed by the user and retailer, and bulk data is reported to the retailer daily in order to calculate the value earned. In step 115 the system provides QR codes or bar codes to the user to show and the retailer to scan, so the bar code is recognized and linked to a single account. In step 120, the system sends confirmation to the retailer that the account has been paid. In step 125, the system provides the first user the ability to assign prepaid funds on behalf of a second user, and provides a financial literacy tutorial with the assignment. In step 127, optionally an avatar archetype is determined depending on the characteristics of the second user. In step 130, the tutorial is commenced and an avatar begins a conversation using WeChat™ or another real-time chat program, discussing a set of topics designed by the system. If the system determines that the user understands the financial literacy portion, in step 135 the funds are released and both users are notified. In step 140 the system tracks the second user's (giftee's) account.

To determine optimal interest rate, the system will perform a series of steps: (1) retailer sets rate and program parameters (reward budget, time frame, target users, target prepay) based on their cost of capital and cost of customer acquisition thus transferring value to consumer (2) consumer uptake is monitored by the system (3) depending on trend, system will adjust to a new rate either up or down (4) system will monitor progress from other programs and take into account sector and other data to help learning (5) the process repeats as desired by the retailer.

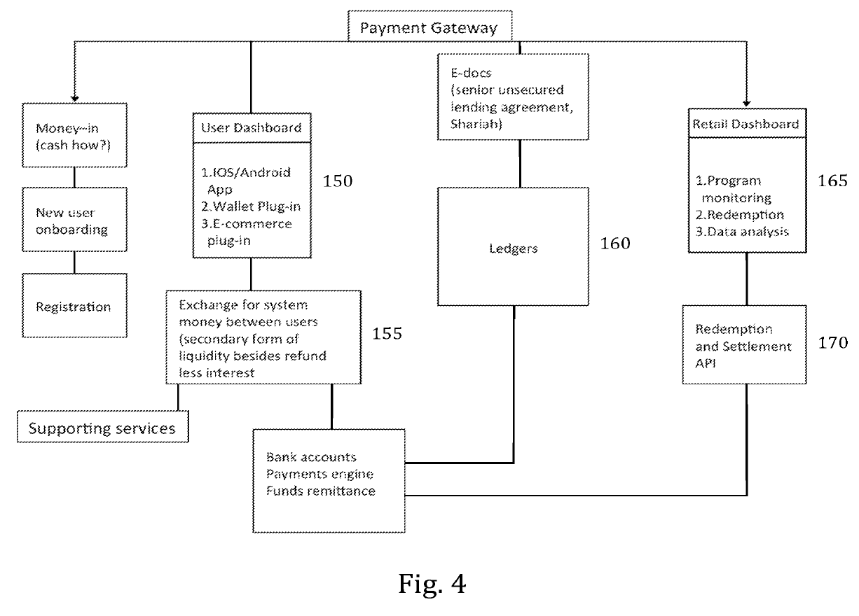

With reference to FIG. 4, the payment gateway is shown. The user dashboard 150 permits a user access to an e-wallet, after he or she is onboarded, registers and funds the e-wallet. The exchange 155 permits money transfer between users. The e-docs comprising lending agreements, etc. are stored centrally in a server, as well as the ledgers 160 used to record balances and transactions. The retail dashboard 165 permits program monitoring, redemption and data analysis, and the redemption and settlement API 170 permits settlement of the transactions to interface with other systems as well.

The system may be used as replacement for insurance, for example dental insurance, wherein the unused amounts of the account are rolled over into the next year, as opposed to insurance premiums which will not carry over. The system may also be used to pre-pay larger purchases such as family vacations and vehicles, etc. wherein the user establishes a regular deposit plan and watches the balance increase months (along with the interest-like increase in purchasing power based on the time the funds remain in the account.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A prepaid bonus system comprising the steps of:
a. determining a discount rate;
b. a consumer depositing money into a mobile secure wallet;
c. the system transferring money into a retailer account;
d. the retailer receiving funds from the consumer;
e. the prepaid account growing by the amount of the funds multiplied by the discount rate;
f. the prepaid account balance showing on an account odometer; and
g. the consumer spending the prepaid balance on purchasing from the retailer.

2. The prepaid bonus system of claim 1, wherein the account odometer the odometer compresses zeros wherein the zeros will shrink when there are zeros between the decimal place and the incrementing numbers, wherein the digits become smaller and shrink in width, and wherein as a zero increments into a higher unit digit, it will expand back to normal font size.

3. The prepaid bonus system of claim 1, wherein the prepaid balance is provided to the consumer as a QR code for the retailer to scan at purchase.

4. The prepaid bonus system of claim 1, wherein the consumer may transfer the prepaid balance to another user.

5. The prepaid bonus system of claim 1, further comprising the step of the consumer communicating with a financial tutor.
